(19) United States
(12) Patent Application Publication
(10) Pub. No.: US 2011/0164698 A1
(43) Pub. Date: Jul. 7, 2011

(54) Systems and methods with non symmetric OFDM modulation

(76) Inventor: Jane (Zhen) Wu, Ottawa (CA)

(21) Appl. No.: 12/656,206

(22) Filed: Jan. 21, 2010

Related U.S. Application Data
(60) Provisional application No. 61/202,008, filed on Jan. 21, 2009.

(51) Int. Cl. H04L 27/28; H04L 23/02

(52) U.S. Cl. 375/261; 375/260

(57) ABSTRACT

Non-symmetric OFDM system may employ different spectrum bandwidths, different FFT sizes, different cyclic prefixes, different symbol duration and different modulation schemes in two ends of the communication. The transmission spectrum can be one contiguous piece or multiple disjoint pieces by modulating zeros to those subcarriers nearby the spectrum boundaries. Transmitter and receiver maybe designed separately and integrated together via a control module to form a transceiver.

### CLAIM OF PRIORITY

This patent application claims the benefit of priority from U.S. Provisional Patent Application No. U.S. 61/202,008 filed on Jan. 21, 2009. This application incorporates by reference the entire disclosure of U.S.A. Provisional Patent Application No. U.S. 61/202,008.

### 1. FIELD OF THE INVENTION

This invention relates generally to the communication systems with non-symmetric OFDM/OFDMA modulation.

### 2. BACKGROUND OF THE INVENTION

OFDM (Orthogonal Frequency Division Multiplexing) was invented in late fifties and has become one of the key modulation schemes in modern communications. The major wireless standards have chosen OFDM as the modulation scheme. These standards include IEEE 802.11a, 802.11g, 802.11n, 802.16/WiMax (World Interoperability for Microwave Access), 3GPP LTE (3^{rd} Generation Partnership Project Long Term Evolution) etc.

In the past 10 years, wireless technology has been booming in an enormous way. There are many wireless standards associated with variety of wireless products that are making peoples' life easier and convenient. Those standards include cellular standards such as GSM (Global System for Mobile), IS-95 (Interim Standard 95)/CDMA2000 (Code Division Multiple Access 2000), 3GPP/UMTS/LTE, WiMax/IEEE 802.16e and local area networks standards such as WiFi/IEEE 802.11x, BlueTooth, Zigbee, UWB/IEEE 802.15x. All those standards had been designed with symmetric consideration and allocated contiguous spectrum, i.e. downward (a.k.a downlink) transmission uses the same bandwidth and same modulation/modulations set as the upward (a.k.a uplink) transmission and the designs are basing on contiguous spectrum. Here we only illustrate a few examples to verify this statement. GSM uses 200 kHz and GMSK (Gaussian Minimum Shift Keying) modulation for downlink and uplink; CDMA uses 1.25 MHz and Direct Spreading Spectrum for downlink and uplink; WiFi 802.11a/g uses 20 MHz spectrum and OFDM modulation with 64-point FFT for downlink and uplink; WiMax and LTE etc. also did the same.

There is a need for non-symmetric OFDM system due to spectrum flexibility and spectrum efficiency and available spectrum locations and service provisions. For instance, to deliver a streaming video needs a constant high data rate in downlink transmission while the needs for uplink transmission can be a slow data channel for necessary feedbacks and signaling therefore a narrower bandwidth spectrum will be enough.

The foregoing objects and advantages of the invention are illustrative that can be achieved by the various exemplary embodiments and are not intended to be exhaustive or limiting of the possible advantages which can be realized. Thus, these and other objects and advantages of the various exemplary embodiments will be apparent from the description herein or can be learned from practicing the various exemplary embodiments, both as embodied herein or as modified in view of any variation that may be apparent to those skilled in the art. Accordingly, the present invention resides in the novel system concepts, methods, arrangements, combinations, and improvements herein shown and described in various exemplary embodiments.

### 3. SUMMARY OF THE INVENTION

As the services or applications or available spectrum locations can be varying and non-symmetric, conventional symmetric designed wireless communication systems for downlink and uplink may be inefficient and inconvenient. For example, the video streaming transmission, the bandwidth demanding is really in downlink direction, i.e. from a BTS (Base Station System) or an AP (Access Point) to a UE (User Equipment) such as a TV, a handset, and a computer etc. Most of the time it is BTS (we may alternatively use BTS or AP as a generic name for a network access node in the forthcoming specification for brevity) transmits while UE only needs to feedback some information occasionally for QoS (Quality of Services) purposes or to request new services by sending a message/messages to BTS. The feedback information may include ARQ (Automatic Repeat Request), CQI (channel quality indicator), location update etc. One common solution for this problem is to allocate different time slots for downlink and for uplink. For example, to schedule BTS transmit most of the time while UE transmit the rest of the time. However, the symmetric designed systems are inconvenient and inefficient. As an example, TDD (time division duplex) OFDM systems are commonly deployed in practice such as WiFi, WiMax etc. Firstly, UE needs to have a similar design as BTS which is complicate, expensive and power inefficient; secondly, UE needs to transmit a whole OFDM symbol even if sometimes it is not needed; thirdly, if schedule too much time for UE to transmit, it will waste of bandwidth while if schedule too few time for UE to transmit, the feedback cycle can be too long to adapt to the channel changes and causes big delays and therefore degrades the QoS.

We will provide brief summaries of various exemplary embodiments. Some simplifications and omissions may be made in the following summary, which is intended to highlight and introduce some aspects of the various exemplary embodiments, but not to limit the scope of the invention. Detailed descriptions of a preferred exemplary embodiment are adequate to those having skills in the art to make and to use the inventive system concepts and methods.

It is believed that OFDM/OFDMA will be the main modulation scheme for wireless transmission and wireless spectrum will be re-allocated time to time and wireless applications are variety and many of them are non-symmetric in nature particularly for packet data communication.

To response those future requirements, various exemplary embodiments are convenient to implement and are efficient in terms of hardware implementation and future wireless network convergence by integrating different standards.

The invention provides systems and methods to facilitate OFDM designs and evolutions where symmetric bandwidth and FFT sizes and cyclic prefix and coding/modulation are not required and where the spectrum may not be contiguous.

The invention also provides solutions to bridge different products basing on different wireless standards and using different pieces of spectrum.

The invention further provides a cost effective solution for some specific applications where non-symmetric data rates for downlink and uplink are always required. A particular example is video distribution system where the required downlink spectrum bandwidth is always much wider than the uplink spectrum bandwidth. On the other hand, there are other applications for which uplink transmission demands more bandwidth than downlink transmission. These applications include wireless meter-reading systems or security monitoring systems in which most of the time the user-end devices report data to network access nodes. We may illustrate the system architecture, methods and embodiments for scenario that downlink needs more bandwidth than uplink. But all the embodiments, system concepts and methods also hold by for the reverse direction.

Various exemplary embodiments are systems and methods that exploit the non-symmetry of the wireless spectrum and wireless applications.

Embodiments including variety of spectrum usage and allocation scenarios which either reuses the current spectrum allocation or future spectrum re-allocation basing on applications, demands and products evolution.

Embodiments provide non-symmetric OFDM transmission and reception methods according to variety of spectrum usage scenarios and OFDM transmission and reception that don't need a contiguous spectrum.

Other embodiments employ OFDM. For example, WiFi OFDM uses 20 MHz spectrum and a FFT size of 64 for downlink transmission and uplink transmission in TDD mode. However, disadvantages of such embodiments are that it is difficult for video streaming application with QoS assurance.

Still other embodiments employ OFDM are WiMax or LTE which also uses symmetric spectrum and FFT size for both downlink and uplink.

### 4. DESCRIPTION OF DRAWINGS

FIG. 1 shows an example of priori art where a symmetric OFDM is employed.

FIG. 2 illustrates a non-symmetric BTS/AP transceiver block diagram in one of the embodiments for transmitting to or receiving from a UE.

FIG. 3 describes a non-symmetric UE transceiver block diagram in one of the embodiments for receiving from or transmitting to a BTS/AP.

FIG. 4 illustrates one scenario of the spectrum allocation to BTS/AP and UE according to one of the embodiments. In this scenario, BTS and UE share a whole piece of spectrum and UE may use a portion of the spectrum.

FIG. 5 describes another scenario of the spectrum allocation to BTS/AP and UE according to one of the embodiments. In this scenario, BTS/AP uses multiple pieces of spectrum while UE may us one piece of spectrum.

FIG. 6 shows further another scenario that BTS/AP and UE may use different spectrums with different bandwidths according to one of the embodiments.

FIG. 7 illustrates non-symmetric OFDM design for BTS/AP and UE according to one of the embodiments.

FIG. 8 shows another non-symmetric OFDM design for BTS/AP and UE according to one of the embodiments.

FIG. 9 shows further another non-symmetric OFDM design for BTS/AP and UE according to one of the embodiments.

### 5. DETAILED DESCRIPTION OF THE INVENTION

The conventional OFDM/OFDMA design is symmetric in the sense that two communication ends use the same bandwidth and same FFT size and the same type of modulations and coding schemes. The well known example is WiFi OFDM where AP and UE share 20 MHz contiguous spectrum timely and employ 64-point FFT and QAM (Quadrature Amplitude Modulation) modulation and convolution coding. The existing wireless communication standards have allocated channel bandwidth equally to downlink and uplink maybe for voice centric reasons. Other examples with symmetry designs include GSM (200 kHz contiguous spectrum for uplink and 200 kHz contiguous spectrum for downlink and both use GMSK modulation), CDMA (code division multiplex access, uses contiguous 1.25 MHz channel for uplink and contiguous 1.25 MHz channel for downlink and both use code division multiplexing), UMTS (universal mobile terrestrial system, uses contiguous 5 MHz spectrum for uplink and contiguous 5 MHz spectrum downlink and both use code division multiplexing), Wimax and LTE (long term evolution), both use equal wide spectrum and same FFT size for uplink and downlink etc.

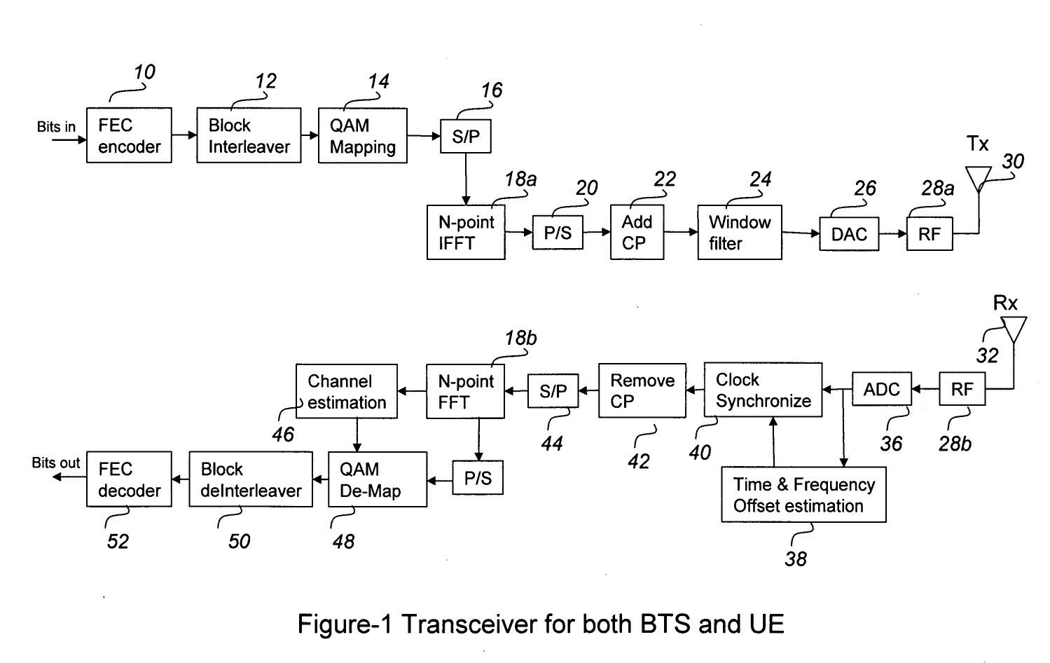

Typical symmetric OFDM transceivers block diagrams for BTS/AP and also for UE are illustrated in FIG. 1 where BTS/AP and UE employ a symmetry design.

When BTS/AP or UE transmits, the source bits will be encoded by forward error correction coding block 10, the outputs of block 10 will be interleaved in block 12 to make the error bits (if there will be) evenly distributed, the bits will be mapped to a constellation point according to a modulation level designated. For example, QPSK will map each group of 2 bits to one QPSK constellation point while QAM-64 will map each group of 6 bits to one QAM-64 constellation point. The serial input constellation points will be converted into parallel format via serial-to-parallel converter block 16 for further processing. An N-point IFFT (Inverse Fast Fourier Transform) or block 18a will be applied to each output of block 16. Block 20 will convert parallel format back to serial format and then a cyclic prefix (CP), a copy of the last portion of the IFFT output—a critical part of OFDM system and its length is predesigned to deal with the multipath distortion, will be inserted in block 22, the stretched data will be filtered in block 24 and up converted in block 26, RF block 28a will further regulate the signal and amplify it for radiation via an antenna 30.

When BTS/AP or UE receives, the desired signal will impinge the receiving antenna 32, the receive RF block 28b will extract the desired signal and ADC (analog to digital converter) block 36 will digitize it and further filter it and regulate it. Block 38 will estimate the timing and frequency offsets and block 40 will use those estimated parameters to further correct the digital data and to provide proper data samples. Block 42 will remove the redundant CP and block 44 will convert the data into parallel format for N-point FFT block 18b to further process it. The block 18b supposes to perfectly reverse the block 18a in ideal situation. Unfortunately, the signal always gets distorted after propagating in the air. Therefore a channel estimation block 46 is needed to estimate the distortion caused by environments and block 48 will use the estimated channel information to compensate the FFT output so that to map back the bits either in soft format or in hard format. A de-interleaver block 50 and a decoder block 52 will further process the bits and recover the original bits transmitted.

To re-iterate, conventional OFDM designs require that spectrum bandwidth, FFT sizes, symbol duration, modulation and coding etc. are equal and symmetric for both BTS/AP and UE and OFDM symbols have been designed on a contiguous spectrum.

In the following, each embodiment of the invention will be described in details.

In one embodiment of the invention, BTS/AP transmitter has one type of spectrum bandwidth, OFDM parameters set and coding and modulation while UE has another type of spectrum bandwidth, OFDM parameters set and modulation and coding.

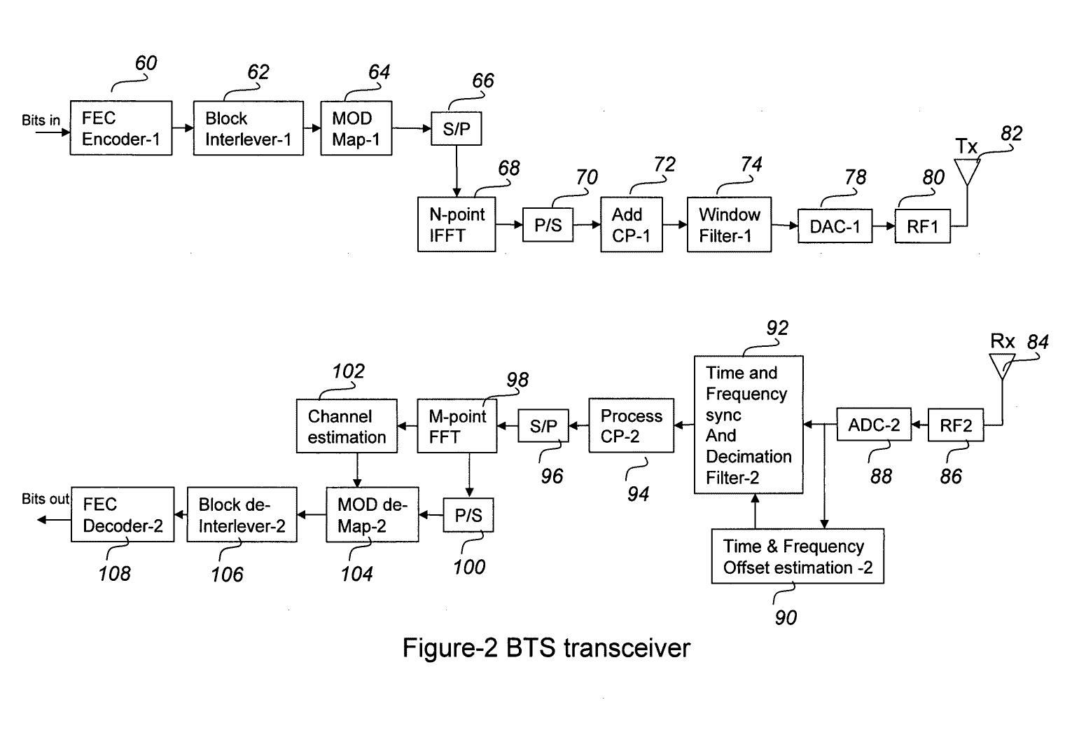

FIG. 2 shows the block diagram of a BTS/AP transceiver according to one embodiment of the invention.

When BTS/AP transmits to a UE or multiple UEs, the source bits will be encoded by forward error correction coding block 60, the outputs of block 60 will be interleaved in block 62; the bits will be mapped to a constellation according to a modulation type in block 64. The serial input constellation points will be converted into parallel format via serial-to-parallel converter 66. An N-point IFFT or block 68 will be applied to each output of block 66. Block 70 will convert parallel format back to serial format and then a cyclic prefix CP-1, either a copy of the last portion of the N-point IFFT output or a pre-defined data sequence, will be inserted in block 72, the data will be filtered in block 74 and up converted in block 78, RF-1 block 80 will further regulate the signal and amplify it for radiation via an antenna 82.

When BTS/AP receives from a UE, the desired signal will impinge the receiving antenna 84, the receive RF-2 block 86 will extract the desired signal and ADC block 88 will digitize the signal and further filter it. Block 90 will estimate the timing and frequency mismatches and block 92 will use those estimated parameters to correct the digital data and to provide proper data samples. Block 94 will process the redundant CP-2 and block 96 will convert the data into parallel format for M-point FFT block 98 to further process it. A channel estimation block 102 to estimate the distortions caused by environments and block 104 will use the estimated channel information to compensate the FFT output so that to map back the bits either in soft format or in hard format. A de-interleaver block 106 and a decoder block 108 will further process the bits and recover the original bits transmitted.

Advantageously, BTS/AP transmitter and receiver may use different spectrum bandwidths and different FFT sizes and different symbol durations and CPs to accommodate asymmetry of spectrum and data rates. This advantage will be further demonstrated in forthcoming embodiments.

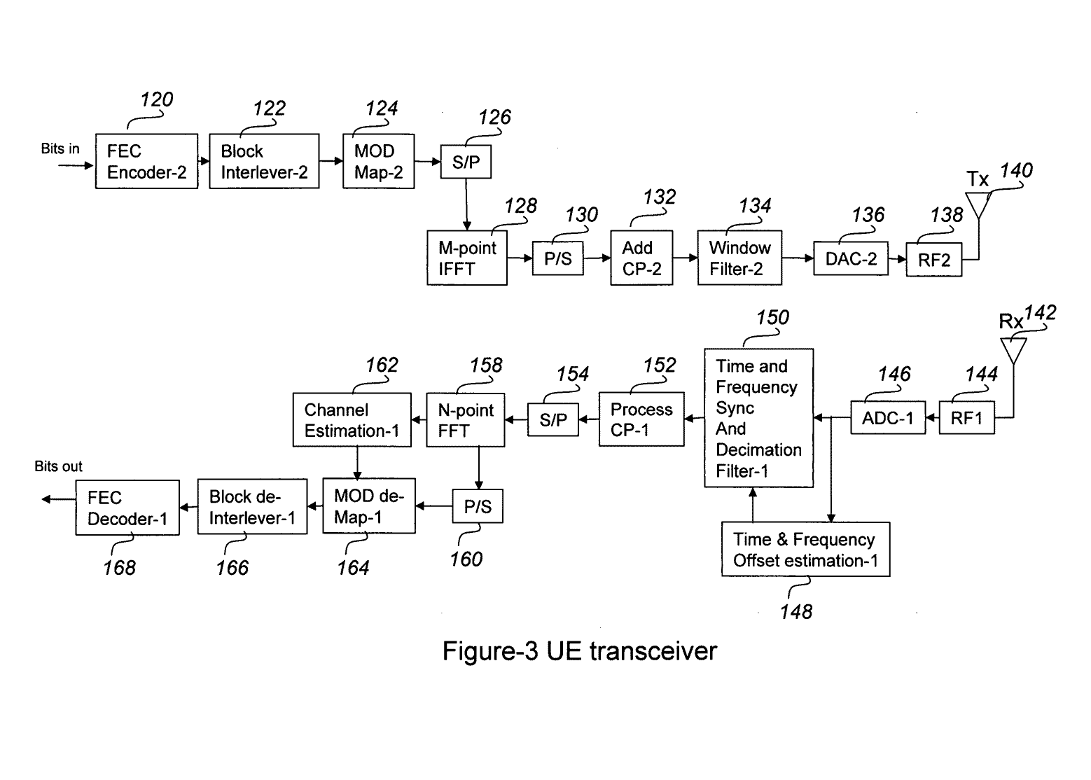

FIG. 3 describes the block diagram of an UE transceiver according to another embodiment of the invention.

When UE transmits to a BTS/AP, the source bits will be encoded by forward error correction coding block 120, the coded bits will be interleaved in block 122; the bits will be mapped to a constellation according a modulation type in block 124. The serial input constellation points will be converted into parallel format via serial-to-parallel converter 126. An M-point IFFT block 128 will be applied to each output of block 126. Block 130 will convert parallel format back to serial format and then a CP-2, either a copy of the last portion of the M-point IFFT output or a pre-defined data sequence, will be inserted in block 132, the data will be filtered in block 134 and up converted in block 136, RF-2 block 138 will further regulate the signal and amplify it for radiation via an antenna 140.

When UE receives from a BTS/AP, the desired signal will impinge the receiving antenna 142, the receive RF-1 block 144 will extract the desired signal and ADC block 146 will digitize the signal and further filter it. Block 148 will estimate the timing and frequency offsets and block 150 will use those estimated parameters to correct the digital data and to provide proper data samples. Block 152 will process the redundant CP-1 and block 154 will convert the data into parallel format for N-point FFT block 158 to further process it. A channel estimation block 162 to estimate the distortions caused by environments and block 164 will use the estimated channel information to compensate the FFT output so that to map back the bits either in soft format or in hard format. A de-interleaver block 166 and a decoder block 168 will further process the bits and recover the original bits transmitted.

Advantageously, UE receiver bandwidth, FFT size, symbol duration and CP modulation and coding etc only match with those of BTS/AP transmitter. UE transmitter bandwidth, FFT size, symbol duration and CP, modulation and coding etc. may use different parameters set from UE receiver.

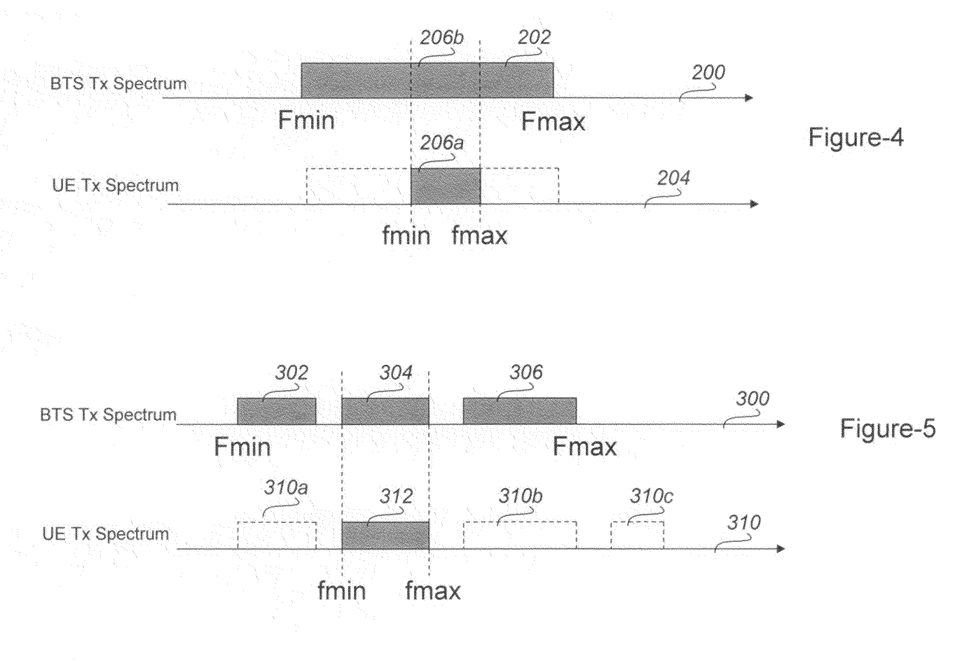

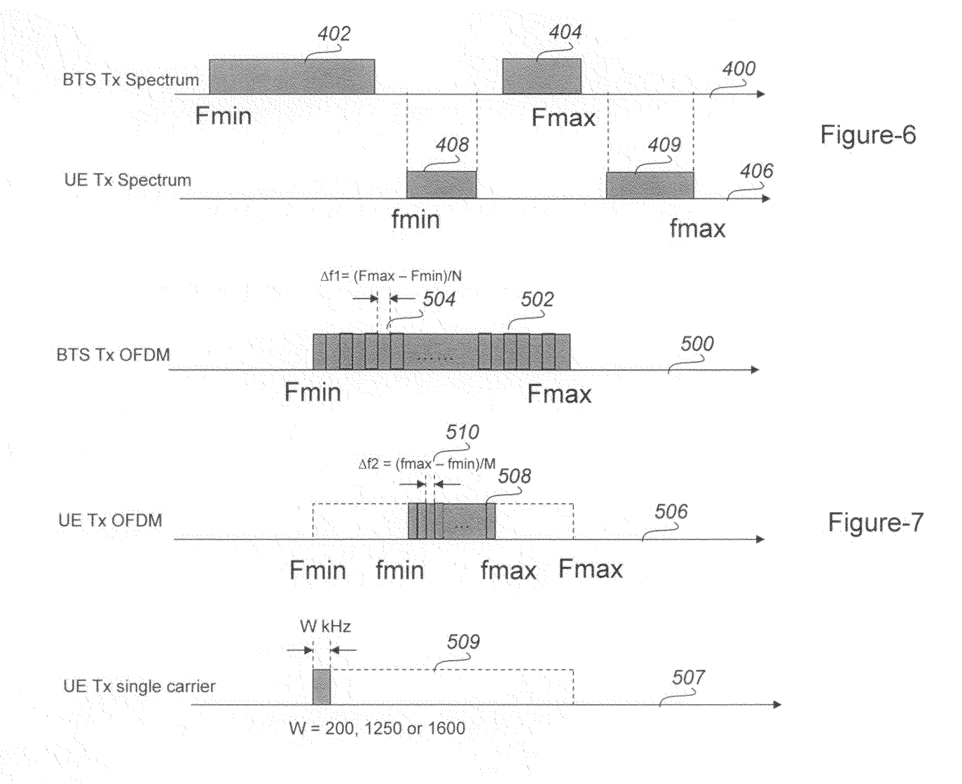

Now we will denote Fmax and Fmin respectively, the highest frequency and the lowest frequency allocated to BTS/AP for transmission. Similarly, we denote fmax and fmin, the highest frequency and the lowest frequency allocated to UE for transmission (refer to FIG. 4, FIG. 5 and FIG. 6).

In another embodiment of the invention, the transmission spectrum scenarios and spectrum allocations to BTS/AP and UE are illustrated in FIG. 4, FIG. 5 and FIG. 6.

In one of the spectrum allocation scenarios (refer FIG. 4), BTS/AP transmitter maybe allocated a contiguous piece of spectrum 202 starting from Fmin and ending at Fmax while UE transmitter maybe allocated a portion of the same contiguous spectrum 206a starting from fmin and ending at fmax, where Fmin≦fmin<fmax≦Fmax.

In another scenario (refer FIG. 5), BTS/AP transmitter maybe allocated multiple pieces of spectrum exemplified in FIG. 5 as 302, 304 and 306 with the lowest frequency Fmin and the highest frequency Fmax. UE transmitter maybe allocated one of the multiple pieces of the spectrum as pointed in 312.

Further in another scenario (refer FIG. 6), BTS/AP transmitter maybe allocated one or multiple pieces of spectrum while UE transmitter maybe allocated another one or multiple pieces of spectrum. BTS/AP transmission spectrum and UE transmission spectrum maybe disjoint.

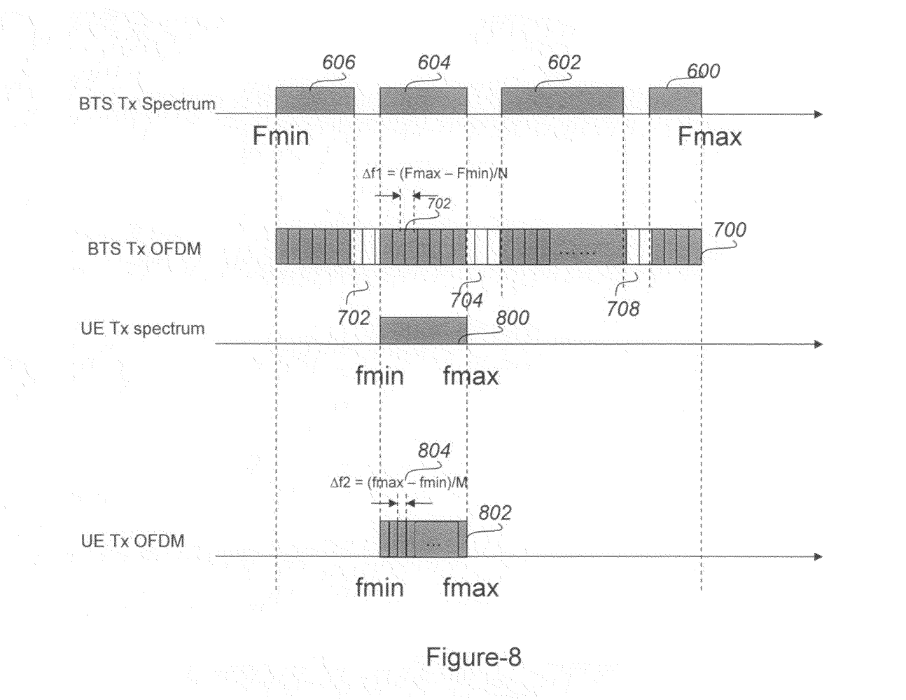

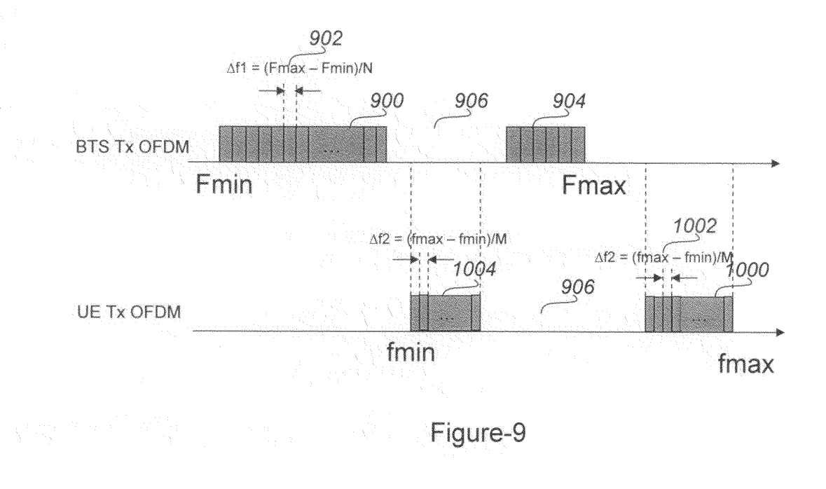

The OFDM subcarriers allocation methods are illustrated in FIG. 7, FIG. 8 and FIG. 9. The BTS/AP transceiver system, as one end of the communication, is illustrated in FIG. 2 and the UE transceiver system, the other end of the communication, is illustrated in FIG. 3.

Further in another embodiment of the invention is to propose that the BTS transmitter may use a contiguous spectrum from Fmin Hz to Fmax Hz and a N-point IFFT while UE transmitter may use a portion of the spectrum from fmin Hz to fmax Hz and where Fmin≦fmin<fmax≦Fmax and UE may use a M-point FFT and maybe N≠M. The subcarrier spacing for BTS transmitter is Δf1=(Fmax−Fmin)/N and the subcarrier spacing for UE transmitter is Δf2=(fmax−fmin)/M (refer to FIG. 7). BTS/AP transmitter may append a cyclic prefix CP-1 and UE transmitter may append a cyclic prefix CP-2. BTS/AP transmitter may have an OFDM symbol duration of 1/Δf1 plus CP-1 while UE transmitter may have an OFDM symbol duration of 1/Δf2 plus CP-2. N and Δf1 and CP-1 maybe different from M and Δf2 and CP-2.

Further in another embodiment (refer FIG. 8), BTS/AP transmitter maybe allocated multiple pieces of spectrum for transmission with the lowest frequency Fmin and the highest frequency Fmax. UE transmitter maybe allocated one or multiple pieces of the spectrum which overlaps with those of BTS/AP transmitter. BTS/AP transmitter may use N-point IFFT with subcarrier spacing Δf1=(Fmax−Fmin)/N and UE transmitter may use M-point IFFT with the subcarrier spacing Δf2=(fmax−fmin)/M (refer to FIG. 8). BTS/AP transmitter may append a cyclic prefix CP-1 and UE transmitter may append a cyclic prefix CP-2. BTS/AP transmitter may have an OFDM symbol duration of 1/Δf1 plus CP-1 while UE transmitter may have an OFDM symbol duration of 1/Δf2 plus CP-2. N and Δf1 and CP-1 maybe different from M and Δf2 and CP-2.

Importantly, those subcarriers nearby to the boundaries of the spectrum pieces maybe modulated by zeros. The number of subcarriers modulating zeros maybe derived according to a rule that may not bother other services in adjacent bands or maybe adaptive to the requirements of the left adjacent channel or right adjacent channel or both.

Further in another embodiment (refer FIG. 9), BTS/AP transmitter maybe allocated one or multiple pieces of spectrum while UE transmitter maybe allocated another one or multiple pieces of spectrum. BTS/AP transmission spectrum and UE transmission spectrum maybe disjoint. BTS/AP transmitter may use N-point IFFT with subcarrier spacing Δf1=(Fmax−Fmin)/N and UE transmitter may use M-point FFT with the subcarrier spacing Δf2=(fmax−fmin)/M (refer to FIG. 9). BTS/AP transmitter may append a cyclic prefix CP-1 and UE transmitter may append a cyclic prefix CP-2. BTS/AP transmitter may have an OFDM symbol duration of 1/Δf1 plus CP-1 while UE transmitter may have an OFDM symbol duration of 1/Δf2 plus CP-2. N and Δf1 and CP-1 maybe different from M and Δf2 and CP-2.

Similarly, those subcarriers at the boundaries of the spectrum pieces maybe modulated by zeros. The number of subcarriers modulating zeros maybe derived according to the rule that may not bother other services in adjacent bands or maybe adaptive to the requirements of the left adjacent channel or right adjacent channel or both.

Further in another embodiment, for a given spectrum comprises of 1 and up to P pieces, downlink OFDM transmitter may use all or a subset of the spectrum and a FFT size N and uplink transmitter OFDM may use all or a subset of the spectrum and FFT size M and maybe M≠N; downlink transmission cyclic prefix maybe different from uplink transmission cyclic prefix. Downlink transmitter may append a cyclic prefix CP-1 and uplink transmitter may append a cyclic prefix CP-2 which maybe copies of the last portions of IFFT outputs or pre-defined data sequences.

The BTS/AP system comprises an antenna, RF module and a baseband module. The baseband module comprises a transmitter chain module and a receiver chain module. The transmitter chain comprises an N-point IFFT processor while the receiver chain comprises an M-point FFT processor.

The UE comprises an antenna, RF module and a base band module. The baseband module comprises a transmitter chain module and a receiver chain module. The transmitter chain comprises an M-point IFFT processor while the receiver chain comprises an N-point FFT processor.

The BTS/AP transmission maybe modulating subcarriers by zeros nearby spectrum boundaries and also those vacant areas that are not allocated to BTS/AP. The UE transmission always modulating subcarriers with zeros nearby spectrum boundaries and also those areas that are not assigned to UE. The amount of subcarriers modulating zeros will be derived according to not bothering other services in adjacent bands or maybe adaptive to the requirements of the left adjacent channel or right adjacent channel or both.

In the case that UE spectrum is overlapped with BTS spectrum; the transmitters may be scheduled not to transmit simultaneously in the common spectrum area. In other words, if BTS transmit, then UE must be listening and not transmit, vise versus.

In the case that UE spectrum is overlapped with BTS spectrum, the transmitters may be scheduled to transmit simultaneously but BTS may modulate its subcarriers by zeros within common area with UE. Furthermore the subcarriers at the spectrum boundaries of UE will be further regulated by modulating zeros to reduce the inter carrier interferences. The amount of subcarriers modulating zeros maybe derived according to the rule that may not bother other services in adjacent bands or maybe adaptive to the requirements of the left adjacent channel or right adjacent channel or both.

We claim:

1. A bi-directional OFDM/OFDMA communication system comprising of non-symmetric transmission parameters
A transmitter in one direction may use a spectrum with W1 Hz in total and an FFT size N and a cyclic prefix CP-1 and an OFDM symbol duration T1 and a modulation set-1 and a coding set-1.
A transmitter in reverse direction may use a spectrum with W2 Hz in total and an FFT size M and a cyclic prefix CP-2 and an OFDM symbol duration T2 and a modulation set-2 and a coding set-2;
A UE receiver using an FFT of size N and a modulation set-1 and coding set-1 to receive the signal transmitted from BTS/AP within W1 Hz;
A BTS/AP receiver using an FFT of size M a modulation set-2 and coding set-2 to receive the signal transmitted from a UE within W2 Hz.

2. The system comprising of non-symmetric transmission parameters, according to claim 1, wherein the transmitter spectrum bandwidth and FFT size in one direction maybe different from those of another transmitter in reverse direction.

3. The system comprising of non-symmetric transmission parameters, according to claim 2, wherein the downlink transmission may use W1 Hz while the uplink transmission may use W2 Hz and uplink transmission spectrum may overlap with downlink transmission spectrum.

4. The system comprising of non-symmetric transmission parameters, according to claim 3, wherein the downlink transmission may use W1 Hz while the uplink transmission may use up to 200 kHz.

5. The system comprising of non-symmetric transmission parameters, according to claim 2, wherein the spectrum for downlink transmission comprises of one to multiple pieces and the spectrum for uplink transmission comprises of one to multiple pieces. The downlink transmission spectrum maybe overlap with uplink transmission spectrum or downlink spectrum and uplink spectrum maybe disjoint.

6. The system comprising of non-symmetric transmission parameters, according to claim 2, wherein downlink transmission may use an IFFT/FFT of size N and uplink transmission may use an IFFT/FFT of size M and maybe N≠M.

7. The system comprising of non-symmetric transmission parameters, according to claim 6, wherein downlink transmission may use an IFFT/FFT of size N and uplink transmission may use a single carrier (M=1).

8. The system comprising of non-symmetric OFDM transmission parameters, according to claim 1, wherein the downlink OFDM subcarrier spacing maybe different from uplink subcarrier spacing.

9. The system comprising of non-symmetric transmission parameters, according to claim 1, wherein the downlink transmission OFDM cyclic prefix CP-1 maybe different from uplink transmission OFDM cyclic prefix CP-2.

10. The system comprising of non-symmetric transmission parameters, according to claim 9, wherein the downlink transmission OFDM cyclic prefix CP-1 maybe a pre-defined data sequence and uplink transmission OFDM cyclic prefix CP-2 maybe a pre-defined data sequence.

11. The system comprising of non-symmetric transmission parameters, according to claim 1, wherein the downlink transmission and uplink transmission may use different modulation sets and different encoding methods.

12. The system comprising of non-symmetric transmission parameters, according to claim 11, wherein the downlink transmission may use QAM modulation sets while the uplink modulation may use BPSK or QPSK or 8-PSK or GMSK or FM or AM or a combination of them.

13. The system comprising of non-symmetric transmission parameters, according to claim 1, wherein the downlink receiver demodulation and decoding parameters match with downlink transmitter parameters and uplink receiver demodulation and decoding parameters match with uplink transmitter parameters.

14. The system comprising of non-symmetric transmission parameters, according to claim 3, wherein the downlink transmission may use up to 200 kHz with single GMSK modulation while the uplink transmission may use W2 Hz with OFDM modulation.

15. The system comprising of non-symmetric transmission parameters, according to claim 6, wherein uplink transmission may use a single carrier (M=1) Code Division Multiplexing and downlink transmission may use an IFFT/FFT of size N>1.

16. A method for non-symmetric bi-directional OFDM communication:
Divide the downlink spectrum into pieces of [Fmax−Fmin]/N Hz each;
Divide the uplink spectrum into pieces of [fmax−fmin]/M Hz each;
Modulating zeros for those subcarriers nearby the boundaries of the allocated spectrum for both downlink and uplink.
The number of subcarriers modulating zeros adapts to the requirements of the adjacent channel.
Schedule the transmissions in overlapped spectrum to avoid bi-direction transmissions collision of each other.

17. A method for non-symmetric bi-directional OFDM communication, according to claim 16, wherein the transmission in one direction (downlink or uplink) may use a contiguous spectrum from Fmin to Fmax and the subcarrier spacing maybe calculated as [Fmax−Fmin]/N while the transmission in reverse direction (uplink or downlink) may use a portion of the same spectrum starting from fmin (≧Fmin) and ending at fmax (≦Fmax) and the subcarrier spacing maybe calculated as [fmax−fmin]/M and M maybe different from N.

18. A method for non-symmetric bi-directional OFDM communication, according to claim 16, wherein the transmission in one direction (downlink or uplink) may use multiple pieces of spectrum with lowest frequency Fmin and highest frequency Fmax and the subcarrier spacing maybe calculated as [Fmax−Fmin]/N and the subcarriers nearby the boundaries of the allocated spectrum maybe modulated by zeros; wherein the transmission in reverse direction may use one or multiple pieces of spectrum with lowest frequency fmin and highest frequency fmax and the subcarrier spacing maybe calculated as [fmax−fmin]/M and the subcarriers nearby the boundaries of the allocated spectrum maybe modulated by zeros and the number of subcarriers modulating zeros adapts to the requirements of the adjacent channel.

19. A method for non-symmetric bi-directional OFDM communication, according to claim 16, wherein schedule a transmission in overlapped spectrum means either to allow only one end (say BTS/AP) transmits and another end (say UE) receives, or they can simultaneously transmit but BTS/AP or UE maybe modulating zeros for those subcarriers within the overlapped spectrum.

20. A method for non-symmetric bi-directional OFDM communication, according to claim 16, wherein the transmission in one direction (downlink or uplink) may use one or multiple pieces of spectrum with lowest frequency Fmin and highest frequency Fmax and the subcarrier spacing maybe calculated as [Fmax−Fmin]/N while the transmission in reverse direction (uplink or downlink) may use another one or multiple pieces of spectrum with lowest frequency fmin and highest frequency fmax and the subcarrier spacing maybe calculated as [fmax−fmin]/M and M maybe different from N and downlink transmission spectrum maybe disjoint with uplink transmission spectrum.
